(19) United States
(12) Patent Application Publication
(10) Pub. No.: US 2008/0142597 A1
(43) Pub. Date: Jun. 19, 2008

(54) AIMING SYSTEM AND METHOD FOR DIFFUSER ILLUMINATION SYSTEMS

(76) Inventors: Eugene Joseph, Coram, NY (US); Duanfeng He, S. Setauket, NY (US)

Correspondence Address: FAY KAPLUN & MARCIN, LLP, 150 BROADWAY, SUITE 702, NEW YORK, NY, 10038, US

(21) Appl. No.: 11/612,178

(22) Filed: Dec. 18, 2006

(51) Int. Cl. G06K 7/10

(52) U.S. Cl. 235/462.21

(57) ABSTRACT

A barcode reader having a diffuser providing diffused light to a surface including a target barcode, the diffuser including an aiming screen portion, a camera capturing an image of the target barcode and an aiming mechanism projecting an aiming pattern on the surface, the aiming pattern being reflected by the surface, wherein, when a reflection of the aiming pattern creates an aiming image on the aiming screen, the barcode reader is oriented to read the target barcode.

### FIELD OF THE INVENTION

The present invention relates to a system for scanning optical codes formed on specular backgrounds. More specifically, the invention relates to systems for aiming and acquiring a code on a specular background with a portable scanning device.

### BACKGROUND

In many situations it is advantageous to identify and track items that are used in some task or that pass through a supply or distribution chain. For certain items it is not practical to attach tags or other identifying implements, such as when the items are very small or are designed to operate in harsh environments. In those cases, a solution is to direct mark the items, meaning that a barcode or other identification code is directly formed on the item's surface.

Direct marking of items is often used for surgical instruments that are tracked during medical procedures, and for other types of small tools. These often have a specular surface which reflects impinging light. This is often problematic for conventional optical code readers, because the mirror-like surface may reflect images to the camera that distort and make it difficult to read the code. Angling the barcode surface to reduce reflections makes it more difficult to aim the device so that the barcode is read correctly.

### SUMMARY OF THE INVENTION

A barcode reader having a diffuser providing diffused light to a surface including a target barcode, the diffuser including an aiming screen portion, a camera capturing an image of the target barcode and an aiming mechanism projecting an aiming pattern on the surface, the aiming pattern being reflected by the surface, wherein, when a reflection of the aiming pattern creates an aiming image on the aiming screen, the barcode reader is oriented to read the target barcode.

An aiming mechanism for a barcode reader having an aiming laser projecting an aiming pattern to a surface including a target barcode along a line substantially parallel to an optical axis of a camera of the barcode reader and an aiming screen displaying an aiming image which is a reflection of the aiming pattern by the surface, wherein, when the aiming image appears on the aiming screen, the camera of the barcode reader is oriented to read the target barcode.

### BRIEF DESCRIPTION OF DRAWINGS

FIG. 1 is a diagram of a barcode reader with an observation window according to an exemplary embodiment of the present invention.

FIG. 2 is a diagram showing an exemplary camera aiming configuration according to the present invention.

FIG. 3 is a diagram showing a second exemplary embodiment of a barcode reader according to the present invention.

FIG. 4 is a diagram showing an exemplary conical diffuser according to the present invention.

FIG. 5 is a diagram showing an exemplary disk-shaped diffuser according to the present invention.

FIG. 6 is a diagram showing a perspective view of the exemplary conical diffuser of FIG. 4.

FIG. 7 is a diagram showing a side view of the exemplary conical diffuser of FIG. 4.

### DETAILED DESCRIPTION

The present invention may be further understood with reference to the following description and to the appended drawings, wherein like elements are referred to with the same reference numerals. The present invention relates to a system for scanning optical codes formed on specular backgrounds. More specifically, the invention relates to systems for aiming and acquiring a code on a specular background with a portable scanning device. Throughout this description, the term specular will be used consistent with its common meaning, e.g., of, relating to, or having the qualities of a mirror. That is, the specular background may be any reflective surface to which a barcode is directly applied (e.g., engraved), affixed, etc.

Specular background surfaces offer difficult challenges for barcode reading systems. Those surfaces reflect the illumination source, create highlights that destroy the data of the barcode within the highlight, and reflect images of the reader device back to the reader. To reduce these problems, a diffuse light source rather than a point source is used to illuminate the barcode. However, if the camera of the reader is aimed orthogonally at the surface containing the barcode, the reflection of the camera itself can be seen superimposed on the image of the barcode. This makes the barcode unreadable. The exemplary embodiments of the present invention provide a barcode reader system that can read a barcode formed on a reflective surface and which provides a simple way of aiming the device so the barcode can be acquired.

Direct Part Marking (DPM) barcodes are often formed on parts with reflective surfaces, when the part is small, is designed for use in harsh environments, or for other reasons a separate tag cannot be used. To scan this type of barcode (or any barcode on a specular background), a diffusive surface of the reader is used to illuminate the barcode, so that the light reflected by the reflective surface forms a background for the barcode. The image of the barcode and the reflection of the diffuser must be aligned to form overlapping images into a camera of the reader, posing an additional challenge to aiming the device.

To read a barcode on a reflective surface, the ideal orientation for the camera is at an angle to the barcode to prevent interference by reflections. The aiming mechanism thus also guides the orientation of the reflective barcode bearing surface, so that the camera sees the reflection of the diffuser. Solutions to aim the reader correctly may include using large diffusers or video preview devices to determine the correct alignment. The former is impractical for small, portable devices. The latter adds significant expense and complexity to the reader system.

According to the exemplary embodiments of the present invention, the user may visually confirm the alignment of the camera and diffuser with the barcode. This alignment prevents distortions of the barcode image due to the camera seeing its own reflection. It also helps to keep the reflection of the diffuser on the camera, to provide a suitable background to the barcode.

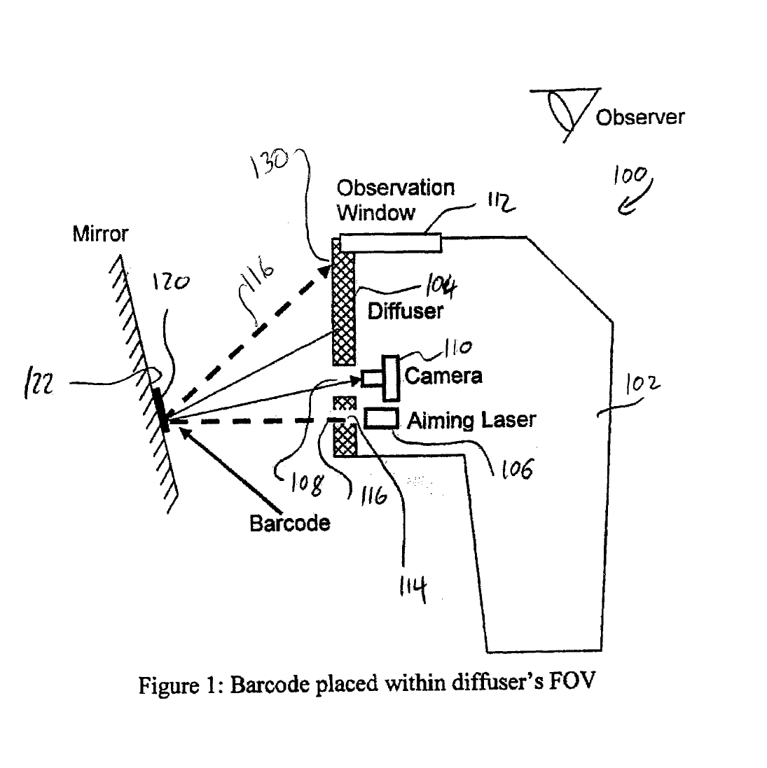

FIG. 1 shows a reader device 100 according to the present invention. The reader device 100 comprises a housing 102 that may be shaped and dimensioned to be hand held by a user. A diffuser 104 forms one side of the housing 102, and provides a diffuse source of light that forms the background for barcodes formed on a specular surface 122. The diffuser 104 may be made from a translucent material or from a transparent material modified with a surface texture to provide the diffuse light. The source of light (not shown) may be an LED, an incandescent bulb or other luminous element disposed in the housing 102, behind the diffuser 104.

As will be described in greater detail below, this style of reader device 100 is generally designed to be held by the user such that pointing the diffuser 104 and camera 110 toward the barcode 120 to be read, the diffuser 104 and the camera 110 will be facing away from the user. Thus, this exemplary embodiment of the reader device 100 is designed based on such an operable orientation. However, those skilled in the art will understand that there may be other reading devices that are designed to be oriented in a different manner for reading a barcode. The present invention may also be implemented on these other type of readers consistent with the principles described herein.

According to the exemplary embodiment, the camera 110 sees the barcode 120 disposed on the reflective surface 122, and acquires its image. Those skilled in the art will understand that more specifically, the camera 110 sees the reflection of the diffuser 104 from the specular background 122. The barcode 120 prevents some of the light from the reflection of the diffuser 104 from reaching the camera 110 and thus forms a contrast on the image. This contrast is then analyzed to read the barcode 120. The camera 110 lens may be behind the plane of the diffuser 104. A camera window 108 may be formed through the diffuser 104 to expose the camera 110 and provide a line of sight to the barcode 120. The camera window 108 may be offset from the center of the diffuser 104 to promote acquiring a distortion-free image of the barcode 120.

The exemplary laser aiming mechanism comprises an aiming laser 106 placed behind an aiming window 114 of the diffuser 104. The aiming window 114 may be a separate window from the camera window 108 or the aiming laser 106 may be situated such that the camera window 108 may also serve as the aiming window 114. The aiming laser 106 generates an aiming pattern that is reflected by the reflective surface 122 bearing the barcode 120 in a direction generally towards the reader device 100. Lines 116 show an exemplary path followed by light from the aiming laser 106 to the barcode 120 and back to the reader device 100. Those skilled in the art will also understand that the aiming laser 106 is not limited to being a laser, but may be any type of light source that can create a focused beam of light or aiming pattern for use as described herein.

The operator can adjust the position and orientation of the reader device 100 to change the location of the reflection of the aiming pattern. The term aiming pattern is used herein to describe the light produced by the aiming laser 106. In this example, the light is a narrow beam laser light that produces an aiming pattern resembling a dot (or spot) of light on the reflective surface 122. By locating the reflection of the aiming pattern on an outer area of the diffuser 104, the operator ensures that the camera 110 sees a central area (or a large contiguous portion) of the diffuser 104 reflected by the reflective surface 122, behind the barcode 120. That is, the camera 110 is oriented that it will see the reflection of the diffuser 104 without any breaks such as from the outside perimeter of the diffuser 104, the camera window 108 or the aiming window 114. Those skilled in the art will understand that this orientation is based on the relative positions of the camera 110, the aiming laser 106 and their respective windows 108, 114. That is, the aiming laser 106 needs to be oriented relative to the camera 110 such that when the aiming pattern falls on the outside portion of the diffuser 104, the camera 110 is seeing the optimum portion of the diffuser 104 for reading the barcode.

The orientation described above helps to ensure that a contiguous portion of the diffuser 104 is reflected by the barcode bearing reflective surface 122, behind the barcode 120. The contiguous portion of the diffuser 104 is unbroken by the camera window 108 or by an edge of the diffuser 104, and thus provides an uniform background when reflected by the reflective surface 122 behind the barcode 120. This provides a good contrast and a clear image for the camera 110.

To visually aim the barcode reader 100 using the aiming pattern that is reflected onto the diffuser 104, it is necessary that the diffuser 104 be visible to the operator. As described above, because the operator is normally situated behind the barcode reader 100 when it is in an operable position, a system has been devised to permit the user to see a portion of the diffuser 104 from behind the device 100. In the exemplary embodiment shown in FIG. 1, a portion of the reader housing 102 forms an observation window 112 through which it is possible to observe a top portion of the diffuser 104. This top portion of the diffuser 104 is referred to as the aiming screen 130. More specifically, the reflected aiming pattern generated by the aiming laser 106 and reflected by the reflective surface 122 onto the aiming screen 130 is seen through the observation window 112, thus providing aiming feedback to the user. The aiming screen may contain a target region on the back of the diffuser 104/aiming screen 130. The target region may be, for example, a circle that is printed or otherwise drawn on the back of the aiming screen 130. The user may use the target region as visual feedback to determine if the aiming pattern is reflected into the target region of the aiming screen 130.

If the user sees the aiming pattern reflected onto the diffuser 104 in the area of the aiming screen 130, the user is assured that the barcode reader 100 is oriented in the correct position to read the barcode 120. If the user does not see the aiming pattern on the aiming screen 130 (through the observation window 112), the user will understand that the barcode reader 100 needs to be reoriented to be in a proper position to read the barcode 120.

The quality of the reflected aiming pattern projected on the user observable screen, such as the aiming screen 130, may also provide useful information about the reflective surface 122 that supports the target barcode 120. For example, if the image of the aiming pattern reflected on the aiming screen 130 (the aiming image) is substantially similar to the aiming pattern, then it can be deduced that the target substrate supporting the barcode is specular. If the aiming image is spread out relative to the aiming pattern, then it can be deduced that the target substrate is partially specular or has some curvature. If there is no observable aiming image, then the target substrate is Lambertian.

It is known that Lambertian background surfaces simplify reading a barcode disposed thereon, while specular surfaces make the task more difficult. Thus, if an image is visible on the aiming screen 130, it may be assumed that aiming assistance is needed for a successful reading of the barcode. If no image is seen, then there may be no need to use the laser aiming mechanism described above.

Those skilled in the art will understand that any aiming pattern may be used according to the invention. However, certain patterns may be easier to generate and more intuitive to use. For example, a single aiming dot as an aiming pattern is easy to generate by focusing the laser to a dot, and is very bright. A dot may be used to aim at very small barcodes, and it is very easy to determine if the corresponding aiming image is also a dot or not. Any non-dot image may be easily recognized by the human eye.

Those skilled in the art will also understand that configurations other than the aiming screen 130 and the observation window 112 may be used to visualize an aiming image that is reflected by the target barcode onto an user observable screen. For example, mirrors, light pipes, optic fibers, or electronic sensing means may be used to determine when the reflected aiming light is within the proper boundaries to successfully read the target barcode.

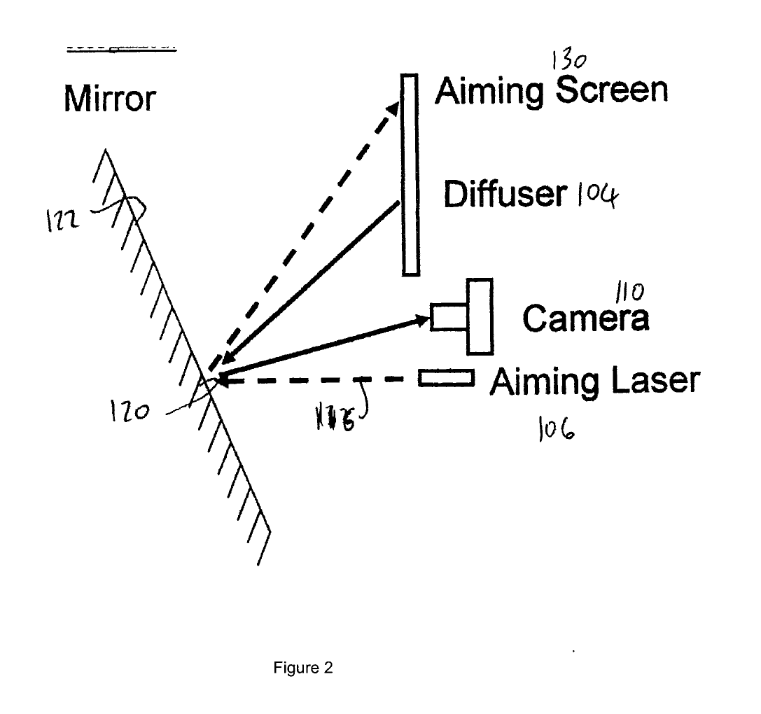

The optical arrangement shown in FIG. 2 suggests other exemplary embodiments of an aiming mechanism according to the present invention. The components (aiming laser 106, camera 110, diffuser 104, aiming screen 130) shown in FIG. 2 may be included in the same type of reading device as illustrated in FIG. 1. Thus, it may be assumed that a user may be able to see the aiming screen 130 through an observation window or some similar device (not shown). In many applications, the path 116 followed by the light of the aiming laser 106 is substantially parallel to the optical axis of the camera 110, while the aiming dot of the laser 106 on the reflective background 122 is within the camera's field of view. The aiming screen 130 and the diffuser 104 are approximately equidistant from the barcode 120 (since the aiming screen 130 is merely an outer portion of the diffuser 104), and are on the opposite side of the camera 110 from the aiming laser 106. As shown in FIG. 2, the aiming laser 106 is placed in close proximity to the camera 110. This placement of the aiming laser 106 results in the camera 110 having a larger contiguous field of view for the diffuser 104. That is, the diffuser 104 provides a larger background for reading the barcode 120. This orientation also results in the barcode 120 being tilted for the reflected aiming pattern to create the aiming image on the aiming screen 130.

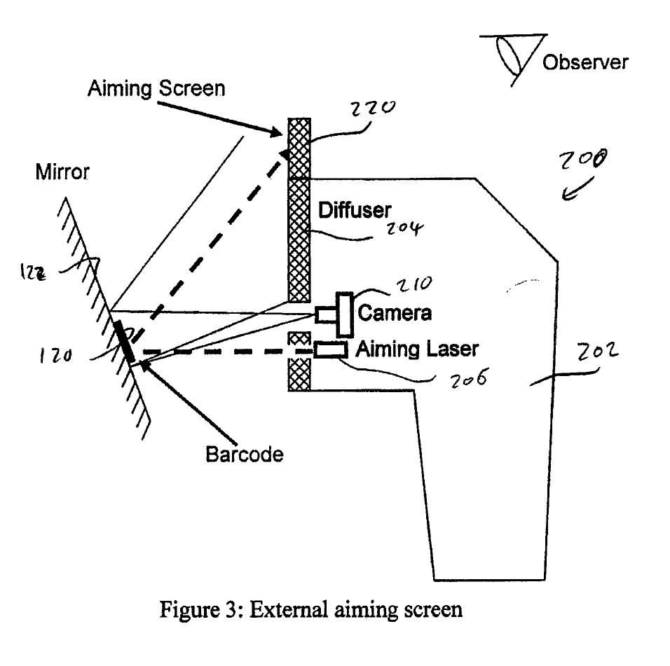

FIG. 3 shows another exemplary embodiment of a barcode reader 200 according to the present invention. The exemplary reader generally includes the same components as described above such as a housing 202, a diffuser 204, an aiming laser 206 and a camera 210. However, the reader 200 comprises an aiming screen 220 that is external to the housing 202 or extends outside of the housing 202. With this configuration it is not necessary to provide a window or other transparent portion of the housing 202 to observe the aiming screen 220. In the exemplary embodiment shown, the aiming screen 220 is on top of the housing 202 (with reference to the orientation of the reader 200 when held by a user). The surface 122 having the barcode 120 is shown as tilted up for proper scanning. In this exemplary embodiment, it may be possible for the user to simultaneously observe both the barcode 122 and the aiming screen 220.

The external aiming screen 220 may be an extension of the diffuser 204,e.g., the diffuser 204 may be constructed such that it extends out from the housing in the entirety of its perimeter or just in the location where the aiming screen 220 is desired. In another exemplary embodiment, the aiming screen 220 may be a separate component that is externally coupled to the housing 202. It should also be noted that while the exemplary embodiment is shown with the aiming screen 220 as being placed on the top of the device 200, it may be possible and desirable to place the aiming screen at a different location around the periphery of the diffuser 204. For example, by placing the aiming screen 220 on the side of the device 200, it may alleviate safety concerns with respect to laser light shining into the eyes of the user. Those skilled in the art will understand that by placing the aiming screen 220 in a different location, the aiming laser 206 may be moved to a different orientation with respect to the camera 210, e.g., rotated so that it is on the opposite side from the aiming screen 220.

Those skilled in the art will understand that various types of diffusers 204 may be used according to the present invention. In addition to a planar diffuser illuminated from behind. For example, the diffuser may be illuminated from one of its edges, for example, if the material is transparent and is made diffusive by applying a texture to its surface. Additional improvements can be made to a side illumination diffuser. For example, forming a mirrored surface on the back side of the diffuser can help to increase its light delivery efficiency by about 50%.

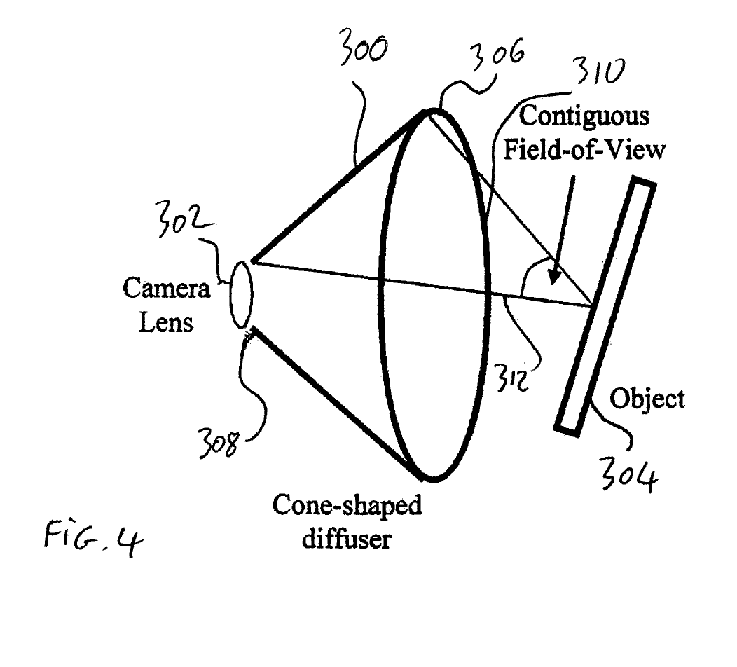

The preceding exemplary embodiments utilized a substantially planar diffuser to illuminate and provide a background to the target barcode. According to the present invention, other diffuser shapes may also be used. The exemplary diffuser 300 shown in FIG. 4 is cone shaped to provide improved conditions for scanning a barcode on a reflective direct marked part. Although the following discussion relates to a symmetrical conical shape of the diffuser for simplicity, those skilled in the art will understand that the diffuser 300 may have a non-symmetrical shape obtained by removing or deforming a portion of the conical surface. Shapes in addition to the triangular shape shown may also be used, such as curved cone shapes.

The exemplary conical diffuser 300 extends from a narrow end 308 at a location adjacent to the camera lens 302 of the barcode reader. A wide end 306 is located at the front of the barcode reader. In one exemplary embodiment, the conical diffuser 300 forms the outer housing of the barcode reader and the narrow end 302 includes a transparent window for the camera lens 302. In another exemplary embodiment, the conical diffuser 300 is located within the housing of the barcode reader and a transparent exit window is placed across the wide end 306. The camera lens 302 sees the diffuser 300 reflected by the target object 304. A contiguous field of view (FOV) 310 is delimited by the lines 312 extending respectively from the edges of the wide end 306 and of the narrow end 308. The continuous FOV comprises a portion of the overall FOV of the diffuser that is not disrupted by reflections of the camera lens 302 or by the edges of the conical diffuser 300. The FOV refers to the portion of the diffuser 306 that is seen by the camera lens 302 as reflected from the object 304.

The ease of aiming and use of the barcode reader is directly related to the maximum contiguous FOV (MCFOV) for a given configuration. The larger the MCFOV that the diffuser can present to the target barcode, the more easily it can be read. In the exemplary embodiment, the MCFOV is bound on the outside by the dimensions of the reader device head, and on the inside by the dimensions of the camera lens 302.

The largest MCFOV can be obtained by maximizing the size of the wide end 306 and minimizing the size of the narrow end 308. Selecting a substantially conical shape of the diffuser satisfies these conditions, and is one way of maximizing the MCFOV of the barcode reader. Moving the opening of the camera to a location offset form the center of the diffuser is another way of increasing the MCFOV of the device. This may be accomplished by physically moving the camera, or by using mirrors or other optical devices. To achieve the best performance, bends, folds, turns and other features of the diffuser should be avoided. Uneven portions of the diffuser surface can cause unevenness in the apparent brightness of the illuminated diffuser, and reduce the MCFOV of the device.

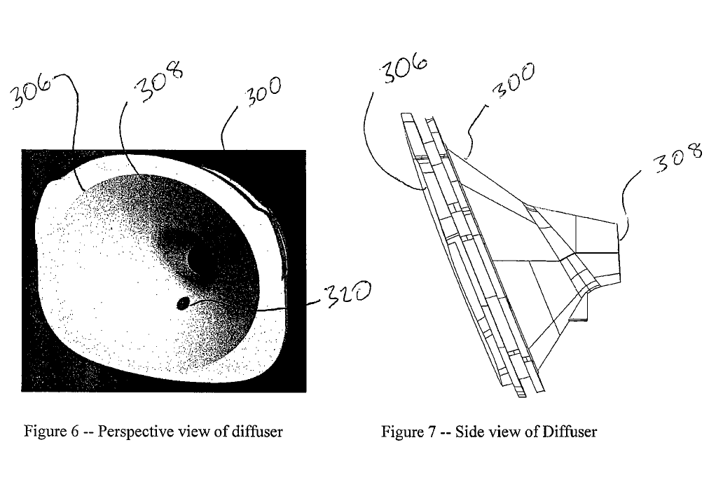

FIG. 6 shows a perspective view of the exemplary conical diffuser 300. While FIG. 7 shows a side view of the exemplary conical diffuser 300. Each of FIGS. 6 and 7 show the narrow end 308 and the wide end 306. It should be noted that the conical diffuser 300 shown in FIG. 6 has a generally conical shape. As described above, to achieve the best performance, bends, folds, turns and other features of the diffuser should be avoided. Thus, the conical diffuser 300 is shown being free of these defects. However, it is not necessary that the conical diffuser 300 be a perfect cone. It is also noted that in FIG. 6, in addition to the narrow end 308 for the camera, there is a second aiming window 320 through which the aiming laser (not shown) may shine the aiming pattern.

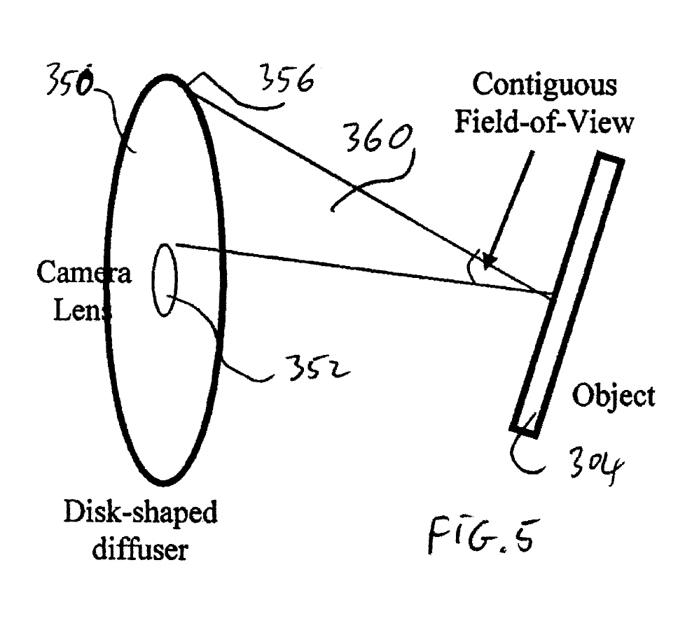

FIG. 5 shows as a comparison the MCFOV for a planar diffuser. The diffuser 350 extends about from the camera lens 352 to the wide edge 356. However, the diffuser 350 is two-dimensional and, thus remains in the same plane as the camera lens 352. In contrast, the conical diffuser 300 described above extends towards the target object away from the plane of the camera lens. As shown in the diagram, the MCFOV 360 of the planar diffuser 350 is smaller than the MCFOV 310 of the conical diffuser 300 described above. This is true for a camera lens and an overall diameter of the two devices being substantially equal.

The present invention has been described with reference to specific exemplary embodiments. Those skilled in the art will understand that changes may be made in details, particularly in matters of shape, size, material and arrangement of parts. Accordingly, various modifications and changes may be made to the embodiments without departing from the scope of the claims below. The specifications and drawings are, therefore, to be regarded in an illustrative rather than a restrictive sense.

What is claimed is:

1. A barcode reader, comprising
a diffuser providing diffused light to a surface including a target barcode, the diffuser including an aiming screen portion;
a camera capturing an image of the target barcode; and
an aiming mechanism projecting an aiming pattern on the surface, the aiming pattern being reflected by the surface, wherein, when a reflection of the aiming pattern creates an aiming image on the aiming screen, the barcode reader is oriented to read the target barcode.

2. The barcode reader according to claim 1, further comprising:
a housing; and
an observation window in the housing, the aiming screen being visible through the observation window.

3. The barcode reader according to claim 1, wherein the aiming screen portion of the diffuser extends beyond a housing of the barcode reader.

4. The barcode reader according to claim 3, wherein the aiming screen extends beyond one of a top surface and a side surface of the housing.

5. The barcode reader according to claim 2, wherein the observation window is formed on a top surface of the housing.

6. The barcode reader according to claim 1, wherein the aiming pattern of the aiming mechanism is projected substantially parallel to an optical axis of the camera.

7. The barcode reader according to claim 1, wherein the aiming pattern and corresponding aiming image comprises an aiming dot.

8. The barcode reader according to claim 1, wherein the camera is disposed between the aiming screen portion and the aiming mechanism.

9. The barcode reader according to claim 1, wherein the aiming mechanism comprises a laser light source.

10. The barcode reader according to claim 1, wherein the diffuser is a substantially conical diffuser having a narrow end adjacent a lens of the camera.

11. The barcode reader according to claim 10, wherein the substantially conical diffuser has a wide end displaced from the lens of the camera towards the target barcode.

12. The barcode reader according to claim 1, further comprising a camera opening of the diffuser adjacent a lens of the camera.

13. The barcode reader according to claim 1, wherein the diffuser comprises a mirrored back surface.

14. An aiming mechanism for a barcode reader, comprising:
an aiming laser projecting an aiming pattern to a surface including a target barcode along a line substantially parallel to an optical axis of a camera of the barcode reader; and
an aiming screen displaying an aiming image which is a reflection of the aiming pattern by the surface, wherein, when the aiming image appears on the aiming screen, the camera of the barcode reader is oriented to read the target barcode.

15. The aiming mechanism according to claim 14, wherein the aiming laser and aiming screen are oriented on opposite sides of the camera.

16. The aiming mechanism according to claim 14, wherein the aiming screen is a portion of a diffuser that produces diffuse light to shine on the surface.

17. The aiming mechanism according to claim 14, wherein the aiming screen extends past a housing of the barcode reader.

18. The aiming mechanism according to claim 14, further comprising:
a transparent window permitting observation of the aiming screen by a user of the barcode reader.

19. The aiming mechanism according to claim 16, wherein the aiming laser is disposed adjacent a substantially conical diffuser having a narrow end near the camera.

20. A barcode reader, comprising
a diffusing means for providing diffused light to a surface including a target barcode, the diffusing means including a viewing means portion;
an imaging means for capturing an image of the target barcode; and
an aiming means for projecting an aiming pattern on the surface, the aiming pattern being reflected by the surface, wherein, when a reflection of the aiming pattern creates an aiming image on the viewing means, the barcode reader is oriented to read the target barcode.
